(19) United States
(12) Patent Application Publication
(10) Pub. No.: US 2020/0124299 A1
(43) Pub. Date: Apr. 23, 2020

(54) AIR-CONDITIONING SYSTEM, AIR-CONDITIONING METHOD, AND ENVIRONMENTAL TESTING CHAMBER

(71) Applicant: HITACHI PLANT SERVICES CO., LTD., Tokyo (JP)

(72) Inventors: Satoru SUGITANI, Tokyo (JP); Makoto TANAKA, Tokyo (JP)

(73) Assignee: HITACHI PLANT SERVICES CO., LTD., Tokyo (JP)

(21) Appl. No.: 16/627,542

(22) PCT Filed: Jun. 25, 2018
(86) PCT No.: PCT/JP2018/024001

§ 371 Date: Dec. 30, 2019

(30) Foreign Application Priority Data
Jun. 30, 2017 (JP) 2017-129672

(51) Int. Cl. F24F 3/14; B01D 53/26

(52) U.S. Cl. CPC F24F 3/1423; B01D 53/261; F24F 2203/1016; F24F 2003/144; F24F 2203/1068; F24F 2203/1032; F24F 2203/1056

(57) ABSTRACT

An air-conditioning system includes: a dehumidifying unit configured to mix air discharged from an environmental testing chamber with outside air for dehumidification and to discharge dry air; a dry air thermal controlling unit configured to thermally control the dry air discharged from the dehumidifying unit to have a temperature lower than a preset air temperature inside the environmental testing chamber; and a dry air heating unit configured to heat the dry air thermally controlled by the dry air thermal controlling unit up to the preset air temperature and to supply the dry air to the environmental testing chamber. The dehumidifying unit preferably discharges the dry air having a dew point temperature of −30° C. or less.

### TECHNICAL FIELD

The present invention relates to an air-conditioning system, an air-conditioning method, and an environmental testing chamber suitable to an environment for performing a performance test of a laser interferometer or the like.

### BACKGROUND ART

A laser interferometer is used in a case where a distance to an object is measured with reference to interference patterns obtained by light emitted from a light source superposed with light reflected from the object. When such a distance is measured precisely, a slight difference in speed of the light in the air, that is, a refractive index of the air due to temperature or humidity of the air leads to a problem.

An example of an isothermal chamber, in which laser measurement or laser processing is performed with high precision, is disclosed in Patent Literature 1. According to Patent Literature 1, air supplied to the isothermal chamber is brought in contact with a heat storage body formed of a plurality of materials, which have different heat capacity and surface areas, not to allow the temperature to fluctuate more than 0.001° C. in either direction. Therefore, laser measurement or laser processing with high precision is performed in the isothermal chamber.

### PRIOR ART DOCUMENTS

### Patent Document

Patent Literature 1: Japanese Patent No. 3672096

### SUMMARY OF THE INVENTION

### Problems to be Solved by the Invention

However, in the isothermal chamber disclosed in Patent Literature 1, the temperature is controlled with high precision, but the humidity is neither controlled nor managed at all. Therefore, it is not known how much the refractive index of the air to be supplied to the isothermal chamber actually fluctuates. Thus, in the technology disclosed in Patent Literature 1, it is unable to determine how much the refractive index of the air fluctuates, which causes an error in measurement with use of a laser interferometer or the like. As a result, it is difficult to say that an environment, in which a precise performance test of a laser interferometer or the like is performed, is obtained. In particular, when a precise performance test of a laser interferometer or the like to be used in an air-free space environment is performed, since the performance test in the space environment is not influenced by humidity, it is considered to be a major problem if a refractive index fluctuation amount of the air due to the humidity cannot be controlled.

An object of the present invention is to provide an air-conditioning system, an air-conditioning method, and an environmental testing chamber for achieving an environment, in which a refractive index fluctuation amount of air to cause an error factor in measurement with use of a laser interferometer or the like, is reduced.

### Means to Solve the Problems

In order to achieve the object described above, an air-conditioning system according to the present invention includes a dehumidifying device configured to mix air discharged from an environmental testing chamber with outside air for dehumidification and to discharge dry air; a dry air thermal controlling device configured to thermally control the dry air discharged from the dehumidifying device so as to have a temperature lower than a preset air temperature inside the environmental testing chamber; and a dry air heating device configured to heat the dry air thermally controlled by the dry air thermal controlling device up to the preset air temperature and to supply the dry air to the environmental testing chamber.

### Advantageous Effects of the Invention

According to the present invention, the environment is achieved, in which a refractive index fluctuation amount of the air to cause an error in measurement with use of a laser interferometer or the like is reduced.

### BRIEF DESCRIPTION OF THE DRAWINGS

FIG. 1 is a diagram illustrating a structure example of an air-conditioning system and an environmental testing chamber according to an embodiment of the present invention.

FIG. 2 is a diagram of a dehumidifying unit in FIG. 1 added with reference numerals.

FIG. 3 is a diagram of a dry air thermal controlling unit in FIG. 1 added with reference numerals.

FIG. 4 is a schematic view of a structure example of a heater to be used in a dry air heating unit.

FIG. 5 is a schematic view of a structure example of a heat storage body to be used in the dry air heating unit.

FIG. 6 is a graph showing relationships between the temperature, humidity, and refractive index of air, provided therein with examples of control ranges for controlling the temperature and humidity of the air in the environmental testing chamber.

FIG. 7 is a graph showing an example of a relationship between the control ranges in FIG. 6 and a refractive index fluctuation amount.

### EMBODIMENTS OF THE INVENTION

A description is given of an embodiment of the present invention with reference to the accompanying drawings. In each drawing, the same reference numerals are used to denote common elements, and duplicate descriptions are omitted.

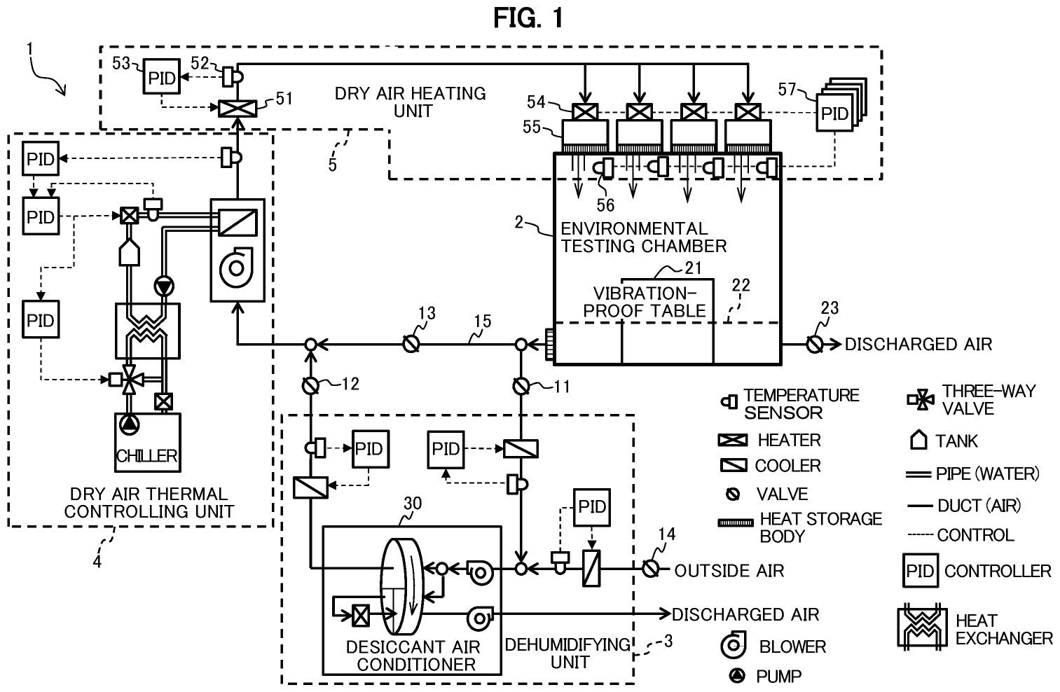

FIG. 1 is a diagram illustrating a structure example of an air-conditioning system 1 and an environmental testing chamber 2 according to the embodiment of the present invention. As illustrated in FIG. 1, the air-conditioning system 1 includes a dehumidifying unit (device) 3, a dry air thermal controlling unit (device) 4, and a dry air heating unit (device) 5, and air-conditions air discharged from the environmental testing chamber 2 to circulate the air back to the environmental testing chamber 2.

The dehumidifying unit 3 includes a dehumidifier such as a desiccant air conditioner 30. The dehumidifying unit 3 supplies dry air to the dry air thermal controlling unit 4, where the dry air is obtained by the air discharged from the environmental testing chamber 2 mixed with outside air being dehumidified by the dehumidifying unit 3. The dry air thermal controlling unit 4 thermally controls the dry air supplied from the dehumidifying unit 3 so as to have a slightly lower temperature than a preset air temperature inside the environmental testing chamber 2 and supplies the dry air to the dry air heating unit 5. The dry air heating unit 5 heats the dry air up to the preset air temperature inside the environmental testing chamber 2 and supplies the heated dry air into the environmental testing chamber 2.

The inside of the environmental testing chamber 2 is shut off from the outside air by an outer wall thereof such as an insulating panel so that only the air air-conditioned in the air-conditioning system 1 is supplied to the environmental testing chamber 2. The environmental testing chamber 2 includes a vibration-proof table 21, and a laser interferometer (not shown) to be tested and the like are placed on the vibration-proof table 21. Further, a grating-shaped raised floor 22 is arranged in the environmental testing chamber 2 and an operator coming into and going out from the environmental testing chamber 2 works on the raised floor 22.

The dry air heating unit 5 of the air-conditioning system 1 is usually arranged above the environmental testing chamber 2. Therefore, the air supplied from the dry air heating unit 5 flows through the environmental testing chamber 2 downward from the upper portion side and flows to the underfloor of the raised floor 22 through openings of the grating-shaped raised floor 22. Then, most of the air flowing to the underfloor of the raised floor 22 is discharged to the dehumidifying unit 3 to return in the air-conditioning system 1, and part of the air is discharged to an outside. A discharge duct to the outside includes a valve 23 to control a discharge amount of the air.

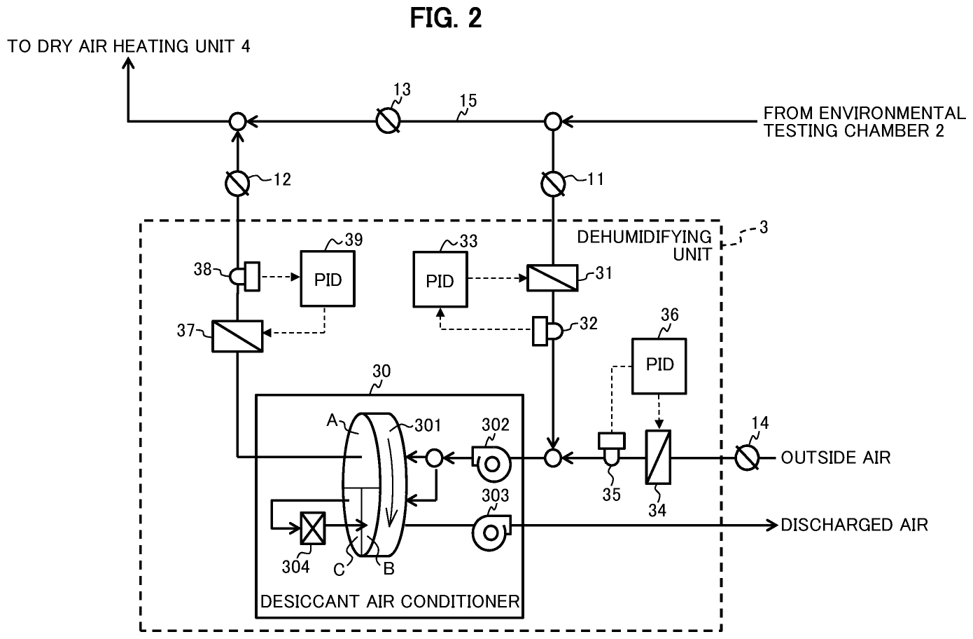

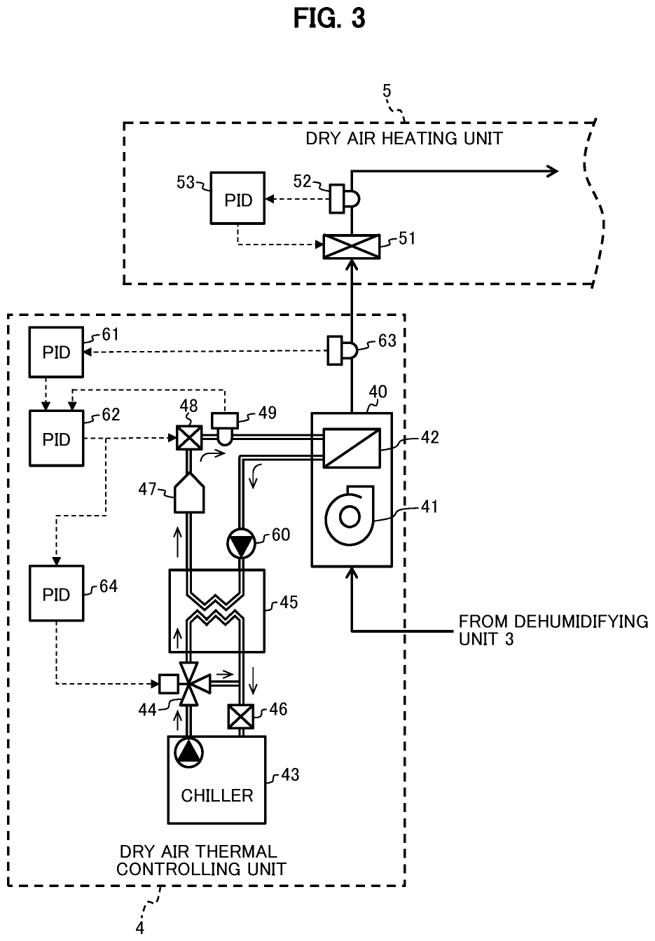

Next, structures of the dehumidifying unit 3 and the dry air thermal controlling unit 4 are described in detail with reference to FIG. 2 and FIG. 3 in addition to FIG. 1. FIG. 2 is a diagram of the dehumidifying unit 3 in FIG. 1 added with reference numerals, and FIG. 3 is a diagram of the dry air thermal controlling unit 4 in FIG. 1 added with reference numerals.

As illustrated in FIG. 1 and FIG. 2, the dehumidifying unit 3 includes the desiccant air conditioner 30 as a main component. The air discharged from the environmental testing chamber 2 and the outside air are cooled by coolers 31 and 34, respectively, to have a temperature suitable for dehumidification, and are then mixed to be supplied to the desiccant air conditioner 30. Temperature sensors 32 and 35 are arranged at the outlets of the coolers 31 and 34, respectively, and controllers (described as PID in FIGS. 1 and 2, the same applies to FIG. 3) 33 and 36 control the coolers 31 and 34, respectively, so that the temperatures obtained from the temperature sensors 32 and 35 reach a predetermined temperature suitable for dehumidification.

Cooling the air to be supplied to the desiccant air conditioner 30 by the coolers 31 and 34, that is, the air to be dehumidified means pre-dehumidification, as well as making the air to be dehumidified have the temperature suitable for dehumidification. In particular, humidity of the outside air is high, and the pre-dehumidification by the cooler 34 reduces a load for dehumidification in the desiccant air conditioner 30.

In FIG. 1 and FIG. 2, the air discharged from the environmental testing chamber 2 and the outside air are mixed after being cooled by the coolers 31 and 34, respectively, but the air discharged from the environmental testing chamber 2 and the outside air may be mixed in advance and then cooled by a single cooler. However, energy efficiency of cooling the air in advance by the two coolers 31 and 34 is generally regarded as better than that of cooling the air later.

The air (air to be dehumidified) supplied to the desiccant air conditioner 30 is blown by a blower 302, to flow through a desiccant rotor 301, in which a moisture adsorption substance is retained, for dehumidification. As the moisture adsorption substance retained in the desiccant rotor 301, a moisture adsorption substance of a high-temperature regeneration type, such as a polymeric adsorbent, silica gel, and zeolite, which adsorbs moisture at low temperature and releases moisture at high temperature, is used.

The desiccant rotor 301 has a cylindrical shape and rotates about the axis of a cylinder in a direction indicated by an arrow in FIG. 1 and FIG. 2, for example. Most of the air to be dehumidified passes through a region A of the rotating desiccant rotor 301 for dehumidification and is blown to the dry air thermal controlling unit 4 as dry air. Further, part of the air to be dehumidified passes through a region C of the desiccant rotor 301, and, after being heated by the heater 304, is returned to the desiccant rotor 301 again to pass through a region B. At this time, the moisture adsorption substance retained in the region B of the desiccant rotor 301 is exposed to the heated air to recover moisture adsorption capacity. Meanwhile, the air passing through the region B contains a large quantity of moisture to be discharged outside the dehumidifying unit 3 (air-conditioning system 1) by a blower 303.

The desiccant rotor 301 is rotated in a direction from the region A to region B to region C to region A and so on. The air to be dehumidified, which has been cooled by the coolers 31 and 34, passes through the region A, and the air having been heated by the heater 304 passes through the region B. Therefore, with the rotation of the desiccant rotor 301, the moisture adsorption substance retained therein adsorbs humidity in the region A, but discharges moisture, which has been adsorbed in the region B, to recover moisture adsorption capacity.

Further, the part of the air to be dehumidified, which has been cooled, passes through the region C. At this time, the moisture adsorption substance heated in the region B is cooled and the air passed through the region C is heated. Therefore, energy required for heating in the heater 304 is reduced.

The air passed through the region A of the desiccant rotor 301 has increased temperature. The air passed through the region A is cooled by a cooler 37 to have temperature substantially equal to that of the air discharged from the environmental testing chamber 2. At this time, a temperature sensor 38 is arranged at the outlet of the cooler 37, and air passed through the cooler 37 is controlled by a controller 39 so as to have a constant temperature.

In the present embodiment, all the air discharged from the environmental testing chamber 2 is not necessarily supplied to the dehumidifying unit 3, and part thereof passes through a bypass duct 15, that is, bypasses the dehumidifying unit 3 to flow to the dry air thermal controlling unit 4. The structure allows, only an amount of air, among the air discharged from the environmental testing chamber 2, necessary for removing humidity increased in the environmental testing chamber 2 to flow to the dehumidifying unit 3. At least after a predetermined time since an operation of the air-conditioning system 1 has passed, humidity increases a little in the environmental testing chamber 2. Therefore, a load for dehumidification by the desiccant rotor 301 is reduced by making part of the air discharged from the environmental testing chamber 2 flow to the bypass duct 15, leading to reducing the desiccant rotor 301 in size.

The amount of air supplied to the dehumidifying unit 3 and the amount of air bypassing the dehumidifying unit 3 are adjusted by control of the opening degrees of respective valves 11, 13. Further, of course, all the air discharged from the environmental testing chamber 2 may be supplied to the dehumidifying unit 3 without arranging the bypass duct 15.

Further, in the present embodiment, a humidity level of the air (dry air), which is blown from the dehumidifying unit 3 to the dry air thermal controlling unit 4, for control is described below. The humidity of the air discharged from the desiccant air conditioner 30 is appropriately set by controlling the temperature in the region B of the desiccant rotor 301, that is, heating intensity of the heater 304, a rotational speed of the desiccant rotor 301, an air volume by the blower 302, or the like.

Further, in the present embodiment, the dehumidifying unit 3 performs dehumidification with use of the desiccant air conditioner 30, but a dehumidifying device is not limited to the desiccant air conditioner 30 and a technology of repeating cooling and heating may be used for dehumidification.

Next, as illustrated in FIG. 3, the dry air thermal controlling unit 4 includes a cooler 42 (dry air cooling device) using cold water as a refrigerant, a heat exchanger 45 (refrigerant cooling device) for cooling the cold water, a chiller 43 (refrigerant cooling device) for cooling the heat exchanger 45, and a heater 48 (refrigerant heating device) for heating the cold water which has been cooled through the heat exchanger 45. The dry air blown from the dehumidifying unit 3 is thermally controlled by the cooler 42 to have a lower temperature than the preset air temperature inside the environmental testing chamber 2, and then is blown to the dry air heating unit 5.

The cooler 42 is arranged in a cooling duct 40 and includes a coil-shaped pipe (not shown: referred to as a cold-water coil hereinafter) through which cold water as a refrigerant (referred to as refrigerant water hereinafter) flows. At this time, the refrigerant water flowing through the cold-water coil is cooled by the heat exchanger 45, and then, is further heated by the heater 48 for control to have a predetermined target temperature of the refrigerant water. Then, the dry air blown from the dehumidifying unit 3 by a blower 41 is cooled by coming in contact with the cold-water coil for control to have a predetermined target temperature of the dry air (temperature slightly lower than the preset air temperature inside the environmental testing chamber 2).

A pump 60 (refrigerant circulating device) and a tank 47 are arranged, in addition to the heater 48, in the middle of the pipe which connects the cooler 42 with the heat exchanger 45 and through which the refrigerant water flows. The pump 60 serves to cause the refrigerant water to flow and circulate through the pipe which connects the cooler 42 with the heat exchanger 45. Further, the tank 47 temporarily stores the refrigerant water to serve to stabilize temperature of the refrigerant water.

Therefore, the refrigerant water with small temperature fluctuation is supplied to the heater 48. Then, the refrigerant water with the small temperature fluctuation is heated by the heater 48, which is controlled by controllers 61 and 62, and supplied to the cooler 42. At this time, the controller 61 compares air temperature which is obtained from a temperature sensor 63 arranged at the outlet of the cooling duct 40, with a preset target air temperature and, based on a difference amount therebetween, calculates a target temperature of the refrigerant water at the outlet of the heater 48. Further, the controller 62 compares temperature of the refrigerant water which is obtained from a temperature sensor 49 arranged at the outlet of the heater 48, with the target temperature of the refrigerant water calculated by the controller 61 and calculates heating intensity of the heater 48, based on a difference amount therebetween.

Further, a three-way valve 44 and a heater 46 are arranged in the middle of a pipe which connects the chiller 43 with the heat exchanger 45 and through which cold water flows. The three-way valve 44 serves to divide the cold water cooled by the chiller 43 into cold water flowing to the heat exchanger 45 and cold water bypassing the heat exchanger 45, and a ratio of the division is instructed by a controller 64. At this time, when the ratio of the cold water flowing to the heat exchanger 45 is increased, the cooling capacity of the heat exchanger 45 is increased, and when the ratio is reduced, the cooling capacity of the heat exchanger 45 is decreased.

The heater 46 arranged around the pipe for the cold water flowing to the chiller 43 serves to stabilize operations of the chiller 43 by slightly heating the cold water as a refrigerant.

In the dry air thermal controlling unit 4 including the structure described above, when the temperature fluctuation of the dry air discharged from the dehumidifying unit 3 is small to have a period less than 1,000 seconds and a fluctuation width less than 0.5° C. for example, the temperature fluctuation is controlled over the heating amount of the heater 48. In contrast, the temperature fluctuation of the dry air discharged from the dehumidifying unit 3 is a relatively large fluctuation of air temperature having a period equal to 1,000 seconds or more and a fluctuation width equal to 0.5° C. or more, for example, the temperature fluctuation is controlled over the flow amount of the refrigerant water to the heat exchanger 45 with opening degree control of the three-way valve 44.

Therefore, dry air having a small temperature fluctuation with respect to the predetermined target temperature is discharged from the dry air thermal controlling unit 4. In FIG. 3, arrows beside the pipes, in which the refrigerant water or the cold water circulates, indicate flowing directions of the refrigerant water or cold water. Further, the refrigerant water or the cold water described above is not limited to water and may be another liquid or gas which can be used as a refrigerant.

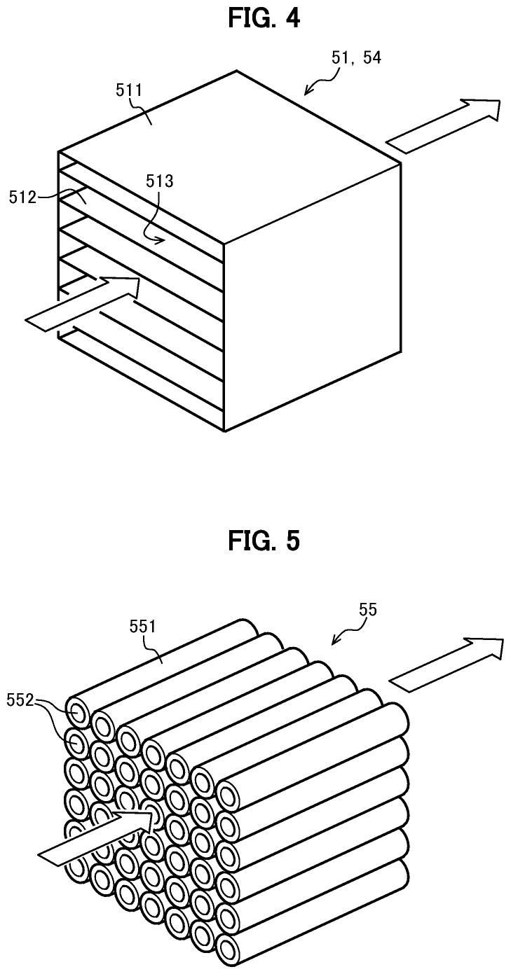

Next, the dry air heating unit 5 is described with reference to FIG. 1, FIG. 4, and FIG. 5. FIG. 4 is a schematic view of a structure example of a heater 51 or 54 to be used in the dry air heating unit 5, and FIG. 5 is a schematic view of a structure example of a heat storage body 55 to be used in the dry air heating unit 5.

As illustrated in FIG. 1, the dry air heating unit 5 includes the heaters 51 and 54, the heat storage bodies 55, temperature sensors 52 and 56, controllers 53 and 57. The dry air supplied from the dry air thermal controlling unit 4 passes through the heater 51 so as to be heated to a predetermined temperature, and further passes through the heaters 54 and the heat storage bodies 55, which are arranged on a ceiling portion of the environmental testing chamber 2, so as to be heated to the preset air temperature inside the environmental testing chamber 2.

The heater 51 is controlled by the controller 53 over heating intensity so that temperature, which is obtained from the temperature sensor 52 arranged at the outlet thereof, is constant. Similarly, the heaters 54 are controlled by the controllers 57 over heating intensity so that temperatures obtained from the temperature sensors 56, which are arranged on the ceiling portion of the environmental testing chamber 2 at the outlets of the heat storage bodies 55, are the same as the preset air temperature inside the environmental testing chamber 2.

Further, as illustrated in FIG. 1, a plurality of sets of the heaters 54 and heat storage bodies 55 are arranged on the ceiling portion of the environmental testing chamber 2 so as to substantially cover a ceiling. Therefore, the dry air kept in a constant temperature is substantially evenly supplied from the ceiling portion into the environmental testing chamber 2 so that the air temperature in the environmental testing chamber 2 is also homogenized.

Further, as illustrated in FIG. 4, each of the heaters 51 and 54 is formed of a heating duct 511 having a plurality of sheet-shaped heaters 512 stored therein. The plurality of sheet-shaped heaters 512 are arranged substantially parallel to the flowing direction (direction indicated by block arrows in the drawing) of the dry air in the heating duct 511 at substantially the same intervals. At this time, the dry air passes through each gap 513 between adjacent two sheet-shaped heaters 512 in the heating duct 511. Thus, a multi-stage parallel flow path is formed in the heating duct 511.

The sheet-shaped heater 512 is formed of resistor bodies, each composed of a glass cloth impregnated with a carbon material, being laminated, for example, or the like. The sheet-shaped heater 512 generates heat substantially uniformly within the sheet surface thereof. The sheet-shaped heater 512 described above is light and thin to have reduced heat capacity. This allows for responding at high speed to thermal control signals instructed from the controllers 53 and 57.

Further, the sheet-shaped heater 512 has a wide contact surface with the air to be heated so that temperature on a heat transfer surface can be low. In addition, in the sheet-shaped heater 512, heating elements are distributed substantially uniformly in the flow path of the air to be heated. Therefore, the heaters 51 and 54 formed of the sheet-shaped heaters 512 as described above allow for reducing temperature fluctuations of the air at the outlets thereof.

Next, the heat storage body 55 arranged downstream of the heater 54, which includes the sheet-shaped heaters 512, is formed of a porous path member 551 having a plurality of holes 552 serving as air flow paths as illustrated in FIG. 5. The porous path member 551 may be formed by a plurality of pipe members whose sides are closely brought in contact with each other, for example. The holes 552 of the porous path member 551 are not limited to have a cylindrical shape and may have a honeycomb-shape. Further, the porous path member 551 may be formed by a plurality of flat plate members stacked in a grid-shape.

The heat storage body 55 absorbs heat when the temperature of the air passing through the holes 552 is higher than the temperature thereof, and discharges heat when the temperature of the air is lower than the temperature thereof. Therefore, the heat storage body 55 is preferably made of a material whose temperature is less likely changed and is usually made of a material having large heat capacity, for example, a metal such as copper or aluminum. Therefore, the temperature fluctuations of the dry air, which is blown into the environmental testing chamber 2 through the holes 552 of the heat storage bodies 55, are effectively reduced.

As described above, according to the air-conditioning system 1 of the present embodiment described with reference to FIG. 1 to FIG. 5, the dry air, whose temperature is precisely controlled, is blown into the environmental testing chamber 2. In that case, the temperature fluctuations of the dry air blown into the environmental testing chamber 2 were confirmed to be reduced at least equal to or less than 0.01° C.

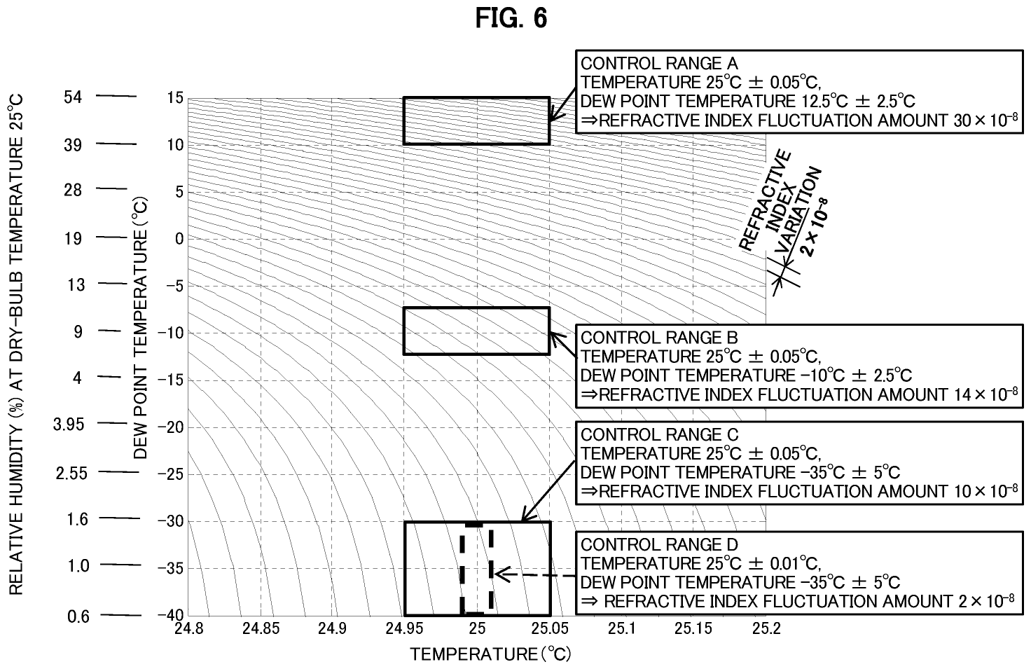

Next, a description is given of relationships between control ranges over the temperature and humidity of the dry air, which is blown from the air-conditioning system 1 into the environmental testing chamber 2, and the refractive index fluctuation amounts in the control ranges with reference to FIG. 6. FIG. 6 is a graph showing relationships between the temperature, humidity, and refractive index of air, provided therein with examples of the control ranges for controlling the temperature and humidity of the air in the environmental testing chamber 2.

In the graph in FIG. 6, the horizontal axis represents the temperature of the air, the vertical axis represents the dew point temperature, and curve lines depicted therein are of equal refractive index lines. In the graph, the equal refractive index lines are depicted when a refractive index changes by 2×10⁻⁸. The equal refractive index lines are calculated based on Edlen's Equation which is well known as an equation for calculating a refractive index of air.

In FIG. 6, humidity is represented by dew point temperature. The dew point temperature is a temperature at which relative humidity is 100 percent when air containing moisture is cooled and can be said as an amount representing an absolute amount of moisture in the air. In contrast, humidity generally represented by percent (%) is relative humidity. Relative humidity changes based on temperature of air (dry-bulb temperature of a so-called hygrometer) at that time, even when an amount of moisture in the air is the same. Thus, a dew point temperature and relative humidity do not have one-to-one correspondence to each other. In FIG. 6, relative humidity at 25° C. of the dry-bulb temperature, which corresponds to each of the dew point temperatures on the vertical axis, is depicted as a guide.

Further, in FIG. 6, four examples of the control ranges are shown for the temperature and humidity of the air in the environmental testing chamber 2 which is controlled by the air-conditioning system 1 according to the present embodiment. For example, in a control range A, the temperature of the air in the environmental testing chamber 2 is controlled to 25° C.±0.05° C., and the humidity, that is, the dew point temperature is controlled to 12.5° C.±2.5° C. In this case, as shown in FIG. 6, fifteen equal refractive index lines pass through a region of the control range A. This means that the refractive index of the air may fluctuate by about 2×10⁻⁸×15, that is, 30×10⁻⁸ when the air in the environmental testing chamber 2 is controlled to have conditions within the control range A.

Similarly, in a control range B, the temperature of the air in the environmental testing chamber 2 is controlled to 25° C.±0.05° C., and the dew point temperature is controlled to −10° C.±2.5° C. In this case, seven equal refractive index lines pass through a region of the control range B. Therefore, the refractive index of the air may fluctuate by about 14×10⁻⁸ when the air in the environmental testing chamber 2 is controlled to have conditions within the control range B.

Further, in a control range C, the temperature of the air in the environmental testing chamber 2 is controlled to 25° C.±0.05° C., and the dew point temperature is controlled to −35° C.±5° C. In this case, five equal refractive index lines pass through a region of the control range C. Therefore, the refractive index of the air may fluctuate by about 10×10⁻⁸ when the air in the environmental testing chamber 2 is controlled to have conditions within the control range C.

Further, in a control range D, the temperature of the air in the environmental testing chamber 2 is controlled to 25° C.±0.01° C., and the dew point temperature is controlled to −35° C.±5° C. In this case, one equal refractive index line passes through a region of the control range D. Therefore, the refractive index of the air may fluctuate by about 2×10⁻⁸ when the air in the environmental testing chamber 2 is controlled have conditions within the control range D.

As described above, FIG. 6 indicates, firstly, “in a case where the temperature fluctuation ranges of the air in the environmental testing chamber 2 are the same, the lower the dew point temperature of the air is, that is, the lower the humidity is, the less refractive index fluctuation amount (amount to be fluctuated) of the air is.”

In the embodiment of the present invention, the dry air dehumidified by the dehumidifying unit 3 is thermally controlled by the dry air thermal controlling unit 4 so as to have a temperature lower than the preset temperature of the environmental testing chamber 2, is heated by the dry air heating unit 5 so as to have the same temperature as the preset temperature of the environmental testing chamber 2, and is blown to the environmental testing chamber 2. Therefore, in the present embodiment, the air in the environmental testing chamber 2 has low humidity, with the result that the refractive index fluctuation amount of the air is reduced compared with a case where the air in the environmental testing chamber 2 is not dried (the dehumidifying unit 3 is not arranged). That is, the air-conditioning system 1 according to the embodiment of the present invention has an advantageous effect of reducing the refractive index fluctuation amount of the air in the environmental testing chamber 2.

Further, as described in FIG. 6, when the dew point temperature is −30° C. or less as in the control range D, the equal refractive index line has a very small dependency characteristic to the dew point temperature. Therefore, at a dew point temperature of −30° C. or less, the refractive index of the air hardly changes even if the dew point temperature changes. This means that the refractive index fluctuation amount of the air is suppressed to about 2×10⁻⁸, as long as the control range for the temperature of the air in the environmental testing chamber 2 is narrowed to between −0.01° C. and 0.01° C. and the dew point temperature is kept at −30° C. or less.

The technology of controlling the air temperature in the environmental testing chamber 2 so as not to fluctuate more than 0.01° C. in either direction may be a known technology as described in Patent Literature 1. Also, in the present embodiment, the dry air heating unit 5 uses the heaters 51 and 54 including the sheet-shaped heaters 512 and the heat storage bodies 55 to reduce temperature fluctuations. Therefore, the temperature of the dry air blown into the environmental testing chamber 2 is easily controlled so as not to fluctuate more than 0.01° C. in either direction.

Then, in the present embodiment, the dehumidifying unit 3 dehumidifies the supplied air until the dry air has a dew point temperature of −30° C. or less. In the present embodiment, the dehumidifying unit 3 includes the desiccant air conditioner 30. With the desiccant air conditioner 30, the dew point temperature can be made to −30° C. or less by appropriately controlling the heating intensity of the heater 304, the rotational speed of the desiccant rotor 301, the air volume by the blower 302, or the like.

That is, in the present embodiment, the air conditioning system 1 controls the temperature fluctuations of the air in the environmental testing chamber 2 so as not to fluctuate more than 0.01° C. in either direction and controls the dew point temperature (humidity) to −30° C. or less. With the control described above, it is apparent from FIG. 6 that the refractive index fluctuation amount of the air in the environmental testing chamber 2 is suppressed to about 2×10⁻⁸ at most.

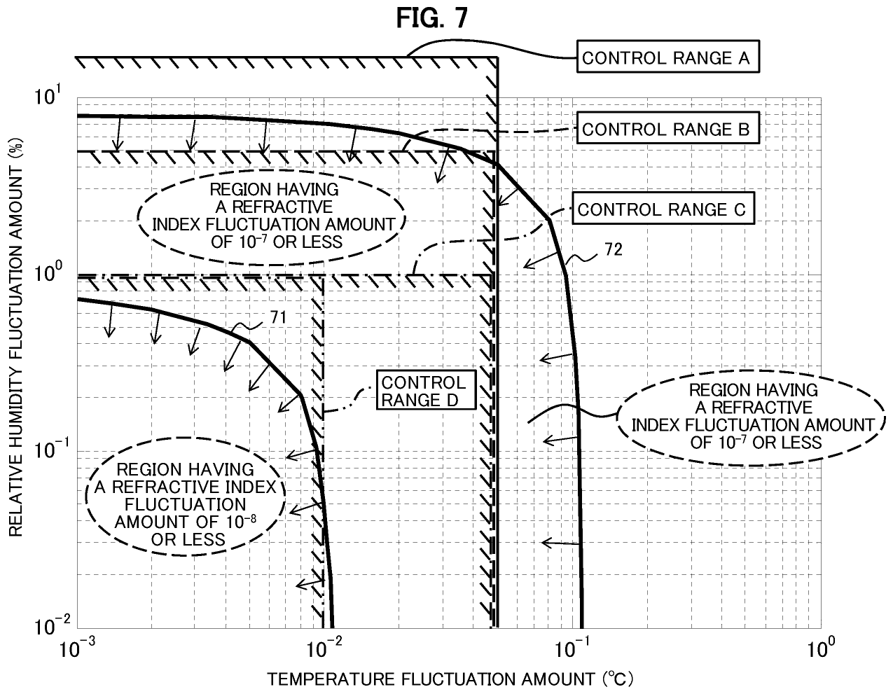

FIG. 7 is a graph showing a relationship between the temperature fluctuation amount, the humidity fluctuation amount, and the refractive index fluctuation amount to be controlled about the air in the environmental testing chamber 2, which is superposed with the control ranges in FIG. 6. The horizontal axis of the graph in FIG. 7 indicates the temperature fluctuation amount of the air in the environmental testing chamber 2, and the vertical axis indicates the relative humidity fluctuation amount of the humidity in the environmental testing chamber 2. In FIG. 7, the relative humidity is represented by relative humidity when the air temperature in the environmental testing chamber 2 is set to 25° C.

The temperature fluctuation amount and the humidity fluctuation amount in FIG. 7 refer to the temperature fluctuation amount and the humidity fluctuation amount which are actually measured in the environmental testing chamber 2. Further, in the graph of FIG. 7, points on two curved lines 71 and 72, each approximated by a polygonal line, represent those having the refractive index fluctuation amounts of 10⁻⁸ and 10⁻⁷, respectively. A region at the lower left side of the curved line 71 (region having arrows therein) is a region where the refractive index fluctuation amount is equal to 10⁻⁸ or less. Further, a region at the lower left side of the curved line 72 (region having arrows therein) is a region where the refractive index fluctuation amount is equal to 10⁻⁷ or less.

Besides, in FIG. 7, the control ranges A, B, C, and D in FIG. 6 are shown. In the control range D in FIG. 6, the temperature is 25° C.±0.01° C. and the dew point temperature of −35° C.±5° C. In FIG. 7, the control range D is set to have the temperature fluctuation amount of 10⁻² or less and to have the relative humidity fluctuation amount of 0.8% or less, which is half of the relative humidity of 1.6% corresponding to the maximum dew point temperature of −30° C. The same applies to the control ranges A, B, and C.

As described above, in the case of the control range D, the refractive index fluctuation amount is suppressed to 10⁻⁸ or less as can be seen in FIG. 7. This result is almost the same as that obtained from FIG. 6.

The present invention is not limited to the embodiment and modification described above, and further includes various modifications. For example, the embodiment and modifications described above have been described in detail in order to better illustrate the invention and are not necessarily limited to include all of the configurations described above. Further, a part of the configuration of the embodiment or modification can be replaced with a configuration of another embodiment or modification. Still further, the configuration of one embodiment or modification may be added with a configuration of another embodiment or modification. Yet further, a part of the configuration of each embodiment or modification may be deleted, added to, or replaced with the configuration contained in another embodiment or modification.

### DESCRIPTION OF SYMBOLS

1 air-conditioning system
2 environmental testing chamber
3 dehumidifying unit (dehumidifying device)
4 dry air thermal controlling unit (dry air thermal controlling device)
5 dry air heating unit (dry air heating device)
11 to 14 valve
15 bypass duct
21 vibration-proof table
22 raised floor
23 valve
30 desiccant air conditioner
31, 34, 37 cooler
32, 35, 38 temperature sensor
33, 36, 39 controller
301 desiccant rotor
302, 303 blower
304 heater
40 cooling duct
41 blower
42 cooler (dry air cooling device)
43 chiller (refrigerant cooling device)
44 three-way valve
46 heater
45 heat exchanger (refrigerant cooling device)
47 tank
48 heater (refrigerant heating device)
49, 63 temperature sensor
60 pump (refrigerant circulating device)
61, 62, 64 controller
51, 54 heater
52, 56 temperature sensor
53, 57 controller
55 heat storage body
511 heating duct
512 sheet-shaped heater
531 porous path member
532 hole

1. An air-conditioning system comprising:
a dehumidifying device configured to mix air discharged from an environmental testing chamber with outside air for dehumidification and to discharge dry air;
a dry air thermal controlling device configured to thermally control the dry air discharged from the dehumidifying device so as to have a temperature lower than a preset air temperature inside the environmental testing chamber; and
a dry air heating device configured to heat the dry air thermally controlled by the dry air thermal controlling device up to the preset air temperature and to supply the dry air to the environmental testing chamber.

2. The air-conditioning system as claimed in claim 1, wherein the dehumidifying device discharges the dry air having a dew point temperature of −30° C. or less.

3. The air-conditioning system as claimed in claim 1, wherein the dehumidifying device is an adsorption-type desiccant air conditioner.

4. The air-conditioning system as claimed in claim 1, wherein the dry air thermal controlling device comprises:
a refrigerant cooling device;
a refrigerant circulating device configured to circulate a refrigerant cooled by the refrigerant cooling device;
a refrigerant heating device configured to heat the refrigerant circulated by the refrigerant circulating device in the middle of the circulation;
a coil-shaped pipe through which the refrigerant heated by the refrigerant heating device flows; and
a dry air cooling device configured to cause the dry air discharged from the dehumidifying device to come in contact with the coil-shaped pipe to cool the dry air.

5. The air-conditioning system as claimed in claim 1, wherein the dry air heating device includes a sheet-shaped heater and a heat storage body, and the dry air thermally controlled by the dry air thermal controlling device is heated by the sheet-shaped heater to be brought in contact with the heat storage body and is supplied to the environmental testing chamber.

6. An air-conditioning method comprising:
a dehumidifying step wherein air discharged from an environmental testing chamber is mixed with outside air for dehumidification to discharge dry air;
a dry air thermal controlling step wherein the dry air obtained in the dehumidifying step is thermally controlled to have a temperature lower than a preset air temperature inside the environmental testing chamber; and
a dry air heating step wherein the dry air obtained in the dry air thermal controlling step is heated up to the preset air temperature and is supplied to the environmental testing chamber.

7. The air-conditioning method as claimed in claim 6, wherein, in the dehumidifying step, the dry air having a dew point temperature of −30° C. or less is discharged.

8. An environmental testing chamber comprising the air-conditioning system as claimed in claim 1.
